(19) United States
(12) Patent Application Publication
(10) Pub. No.: US 2014/0020449 A1
(43) Pub. Date: Jan. 23, 2014

(54) Flow Loop Density Measurement Method

(71) Applicant: Zedi Canada Inc., Calgary (CA)

(72) Inventors: Tokunosuke Ito, Calgary (CA); Andrew Jarman, Edmonton (CA)

(73) Assignee: Zedi Canada Inc., Calgary (CA)

(21) Appl. No.: 13/550,803

(22) Filed: Jul. 17, 2012

(51) Int. Cl. G01N 9/26

(52) U.S. Cl. CPC G01N 9/266
USPC 73/30.02

(57) ABSTRACT

A method of measuring a density of two liquid phases in a mixture with a gas phase. The three phase mixture is fed into an inlet vertical column of a flow loop where the gas phase is separated from a liquid mixture of the two liquid phases. The gas phase rises to an upper section of the inlet vertical column, while the liquid mixture flows to a lower section. A differential pressure of the liquid mixture is measured in the lower section. A density of the liquid mixture is calculated using the measured differential pressure of the liquid mixture. A volume or mass percentage is determined for each of the liquid phases in the liquid mixture. A volumetric flow rate is measured. A volumetric flow rate and accumulated volume of each liquid phase is calculated based on the volume or mass percentage of that liquid phase in the liquid mixture.

### BACKGROUND OF THE INVENTION

A flow loop is a pipe configuration in which a single channel of fluid flow is split into two separate flow channels and later combined into a single channel again. Flow loops exhibit self-balancing characteristics when exposed to a constant external force in a specific orientation. The external physical force may be applied to a flow loop such that a differentiation or separation of content of the fluid flow occurs near the splitting section of the flow loop. The separation may cause the fluid flow through each of the separate channels to have differing characteristics from the original single channel. The difference in the content of the separate channels may be used for measurement and other forms of analysis in order to identify the nature of the fluid flowing through the original single channel. This technique is useful where the original fluid has characteristics that render these types of measurements or other forms of analysis impossible.

The external physical force or energy applied to separate the fluid flow may be extracted as the separate channels of fluid flow combine. When the external energy application and extraction are balanced with a flow loop configuration that induces a desired content separation after the split, the flow loop exhibits a unique ability to adapt to changes in the input flow conditions. If the inlet pressure increases for a short period of time, the merging outlet flow will exhibit a proportional pressure increase with a slight time delay while the flow loop maintains the content of each flow path. For example, application of a magnetic field to a flow loop will separate a fluid containing negatively ionized particles from a remainder of the input fluid.

Also, application of a gravity field to a properly structured flow loop will separate fluids having two different densities. Specifically, the denser fluid will flow in the direction of the gravity field through one separate flow path, while the less dense fluid will flow in the opposite direction through the other separate flow path. The two fluids will be combined at the outlet of the flow loop to regain the original state of the input fluid flow. Where the two fluids have significantly different densities, the buoyancy force will also act on the less dense fluid to guide it in the direction opposite to the gravity field. The more dense fluid will lose potential energy as it flows through a lower separate flow path, but the lost potential energy will be converted into either kinetic energy in the form of an increased flow velocity or another form of potential energy in the form of an increased fluid pressure. The opposite energy conversion occurs for the less dense fluid in a higher separate flow path. An overall energy conservation will be maintained for the flow loop after accounting for energy loss due to friction and subsequent heat generation. The pressure is also balanced in the flow loop under the gravity field.

### SUMMARY OF THE INVENTION

In one embodiment, a method of measuring a flowing volume and density of two liquid phases in a mixture with a gas phase is disclosed. The method comprises providing a flow loop having an inlet vertical column and an outlet vertical column interconnected by a top horizontal section and a bottom horizontal section and feeding a three phase mixture into the inlet vertical column, and wherein a density of the first liquid phase is lower than a density of the second liquid phase. The method includes separating the gas phase from the first and second liquid phases in the inlet vertical column, such that the gas phase flows to an upper section of the inlet vertical column and through the top horizontal section and a liquid mixture of the first and second liquid phases flows to a lower section of the inlet vertical column and through the bottom horizontal section, and measuring a differential pressure of the liquid mixture in the lower section of the inlet vertical column. The method further comprises measuring a flowing volume of the liquid mixture, and calculating a density value for the liquid mixture using the differential pressure. In one embodiment, the diameter of the inlet vertical column is larger than a diameter of the top horizontal section, a diameter of the bottom horizontal section, and a diameter of the outlet vertical column. The differential pressure may be measured using a differential pressure sensor with remote diaphragm seals. The conversion of the differential pressure to the density value for the liquid mixture may be accomplished by dividing the differential pressure by the height between the measuring points of the differential sensor and the gravitational acceleration constant [ρmix=ΔP/(g×h)]. 9The method may further comprise determining a volume percentage of the liquid mixture for the first liquid phase and determining a volume percentage of the liquid mixture for the second liquid phase, and wherein the volume percentage of the liquid mixture for the first liquid phase may be determined by calculating percentage based on the density of the liquid mixture density and the reference density of the first liquid phase and the reference density of the second liquid phase.

In one embodiment, the step of determining the volume percentage of the liquid mixture of the first liquid phase, the volume percentage of the liquid mixture for said first liquid phase is determined by: V1/V=(ρmix−ρ2)/(ρ1−ρ2), wherein: V is the first and second volume; V1 is the first volume; ρmix is the density value for liquid mixture; ρ1 is the first liquid density; and ρ2 is the second liquid density. Also, determining the volume percentage of the liquid mixture for the second liquid phase may be determined by calculating: V2/V=1−V1/V.

In another embodiment, the method may further comprise determining a mass percentage of said first liquid phase in said liquid mixture (m1) and determining a mass percentage of the second liquid phase in the liquid mixture (m1), and wherein the mass percentage of the liquid mixture for the first liquid phase may be determined by calculating: m1/mmix=(V1/V)*(ρmix/ρ1), wherein: mmix is the mass of liquid 1 and liquid 2 mixture in the vertical column volume of V; V1 is the first volume; V is the first and second volume; ρmix is the density for liquid mixture; ρ1 is the first liquid density; and, m1 is the mass percentage of said first liquid phase. The mass percentage of the liquid mixture for the second liquid phase may be determined by calculating: m2/mmix=(V2/V)*(ρmix/ρ2), wherein: mmix is the mass of liquid 1 and liquid 2; m2 is the mass percentage of the second liquid phase; V is the first and second volume; V2 is the second volume; ρmix is the density value for liquid mixture; and, ρ2 is the second liquid density.

As more fully set-out below, the three phase mixture may be under turbulent flow conditions, and wherein the method includes feeding the three phase mixture into a plurality of horizontal pipe sections and beginning the separation of the gas phase from the first and second liquid phases in the horizontal pipe sections before feeding the three phase mixture into the inlet vertical column of the flow loop. The horizontal pipe sections may be configured in a series upstream of the flow loop. Also, in another embodiment, the horizontal pipe sections may be positioned parallel to one another between the split section and the convergence section, and the method includes feeding the three phase mixture through the split section and into the plurality of horizontal pipe sections, and beginning the separation of the gas phase from the first and second liquid phases in the horizontal pipe sections before feeding the three phase mixture through the convergence section and into the inlet vertical section of the flow loop.

In yet another embodiment, a method of measuring a density of two liquid phases in a mixture with a gas phase is disclosed which includes the steps of providing a flow loop, wherein a diameter of an inlet vertical column is larger than a diameter of a top horizontal section, a diameter of a bottom horizontal section, and a diameter of an outlet vertical column. The method further includes feeding a three phase mixture into a series of horizontal pipe sections and beginning to separate a gas phase from a first and second liquid phases in the series of horizontal pipe sections. The three phase mixture is feed into the inlet vertical column of flow loop and the method further comprises continuing to separate the gas phase from the first and second liquid phases in the inlet vertical column, such that the gas phase flows to an upper section of the inlet vertical column and through the top horizontal section and a liquid mixture of the first and second liquid phases flows to a lower section of the inlet vertical column and through the bottom horizontal section. A differential pressure of the liquid mixture in the lower section of the inlet vertical column is measured, and a density value for the liquid mixture using the differential pressure is calculated. Under either turbulent flow and/or laminar conditions, the method further comprises adjusting the differential pressure of the liquid mixture for a friction pressure loss, wherein the friction pressure loss is a pressure drop caused by friction forces in the liquid mixture. Also, the method may include measuring a flow rate of the liquid mixture and calculating a flow velocity of the liquid mixture, estimating the friction pressure loss using the flow velocity, and calculating a gravity differential pressure by subtracting the friction pressure loss from the differential pressure, and then calculating of the density value for the liquid mixture uses the gravity differential pressure. With this embodiment, the method may include measuring a second differential pressure of the liquid mixture in a lower section of the outlet vertical column; and calculating a gravity differential pressure by subtracting the second differential pressure from the differential pressure, then dividing the difference in half and then calculating the density value for the liquid mixture using the gravity differential pressure.

### BRIEF DESCRIPTION OF THE DRAWINGS

FIG. 1 is a schematic view of a three-phase density measurement flow loop.

FIG. 2 is a schematic view of a container depicting differential pressures, heights and cross-sectional areas.

FIG. 3 is a schematic view of the three-phase density measurement flow loop having a plurality of pre-separation horizontal pipe sections.

FIG. 4 is a schematic view of another three-phase density measurement flow loop embodiment having an additional differential pressure measurement point.

### DETAILED DESCRIPTION OF THE PREFERRED EMBODIMENTS

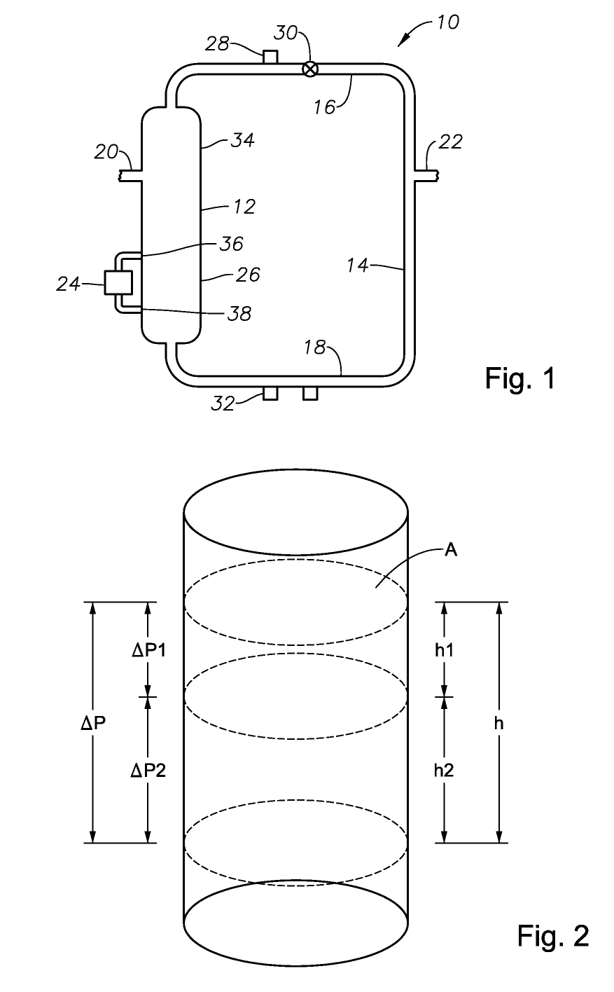

With reference to FIG. 1, three-phase density measurement flow loop 10 may include inlet vertical column 12 and outlet vertical column 14 interconnected by top horizontal section 16 and bottom horizontal section 18. Inlet vertical column 12 may have a diameter that is larger than the diameters of outlet vertical column 14, top horizontal section 16, and bottom horizontal section 18. In one embodiment, inlet vertical column 12 has a diameter of approximately six inches. Inlet 20 may be fluidly connected to inlet vertical column 12, and outlet 22 may be fluidly connected to outlet vertical column 14. In one preferred embodiment, while column 14, horizontal sections 16 and 18 can have the same diameter, the diameter ratio between column 12 and column 14 should maintain the minimum of three (3) or higher. The relative Reynolds number of the fluid in column 12 should be a third of the Reynolds number in column 14, section 16 and section 18 and should be close to Laminar flow to maximize the gas separation efficiency.

Differential pressure measurement system 24 may be positioned on lower section 26 of inlet vertical column 12. Differential pressure measurement system 24 may be a remote seal pressure transmitter. Alternatively, differential pressure measurement system 24 may be achieved by having accurate static (as opposed to differential) pressure sensor with long term stability. According to the teachings of this disclosure, the true differential pressure of the two separate heights in the vertical column 12 is desired. Gas flow meter 28 and valve 30 may be positioned on top horizontal section 16. Gas flow meter 28 may be an eTube™ based gas flow measurement system as described in U.S. Pat. No. 7,653,489 and U.S. Pat. No. 7,623,975, which are both incorporated herein by reference. In another embodiment, gas flow meter 28 may be another differential pressure meter such as a Venturi meter, or could be a linear meter such as a gas turbine meter. Valve 30 may be a ball valve, v-notch ball valve, needle valve or other standard control valve. Liquid flow meter 32 may be positioned on bottom horizontal section 18. Liquid flow meter 32 may be an eTube™ flow meter. In another embodiment, liquid flow meter 32 may be another differential pressure meter such as a Venturi meter, or could be a linear meter such as a turbine meter.

A three phase mixture may be fed through inlet 20 into inlet vertical column 12. The three phase mixture may include a gas phase, a first liquid phase, and a second liquid phase. The first liquid phase may have a lower density than the second liquid phase. Under laminar flow conditions, the gas phase will separate from a liquid mixture of the first and second liquid phases in inlet vertical column 12 due to the force of gravity and the buoyancy force. The gas phase may rise into upper section 34 of inlet vertical column 12, while the liquid mixture may flow into lower section 26. The greater diameter of inlet vertical column 12 may encourage laminar flow for a given flow rate and, in turn, more efficient separation of the gas phase from the liquid mixture. A differential pressure may be measured for the liquid mixture at first vertical position 36 and second vertical position 38 in inlet vertical column 12 using differential pressure measurement system 24. The measured differential pressure value is directly proportional to the density of the liquid mixture. The measured differential pressure value may be used to approximate the density of the liquid mixture, using the following formula:

ρmix=ΔP/(g×h)

wherein

ρmix=density of the liquid mixture,

ΔP=differential pressure,

g=gravitational acceleration,

h=vertical height between measurement points,

more particularly, where ρ is the density of the liquid mixture, ΔP is the differential pressure of the liquid mixture between first vertical position 36 and second vertical position 38, g is the acceleration due to gravity, h is the height difference between first vertical position 36 and second vertical position 38.

In one embodiment, an objective for the liquid side is to measure the volume flow of the two liquids. The density of each liquid will be predetermined by sampling the liquid stream and determining the densities through laboratory analysis. The calculated density will be used (1) in the measurement of the liquid flow rate, and (2) along with known densities of the individual liquids to determine the density percentage of the two liquids.

A physical sample of the liquid mixture may be drawn at the upstream of inlet 20. The laboratory analysis of liquid sample presents the density of the first liquid and the second liquid (ρ_{L1} and ρ_{L2}). The two individual density values and the measured mixture density (ρmix) may be used to determine density percentages of the first liquid phase and the second liquid phase volume in the liquid mixture. In one preferred embodiment, the system measures the volume percentages. Mass values can be determined by multiplying by the liquid densities, but are not required. When the fluids with two (2) separate densities are well mixed, they will separate after a period of time in the static condition as follows.

FIG. 2, which is a schematic view of a container depicting differential pressures, heights, and cross-sectional areas, will now be discussed. Note, like numbers and symbols appearing in the various figures refer to like components and parameters.

As illustrated in FIG. 2, ΔP=ΔP1+ΔP2
Where ΔP=ρmix g h; (g is gravitational acceleration),
   ΔP1=ρ1 g h1; (ρ1 is the lighter density of the two liquid),
   ΔP2=ρ2 g h2; (ρ2 is the heavier density of the two liquid).
      Then the equation simplifies to;

ρmix h=ρ1 h1+ρ2 h2.

The volume can be set to be;

V=A h

V1=A h1

V2=A h2 where A is the cross sectional area of the cylinder.

In addition;

V=V1+V2. The equation A.

Now further modifying the density relationship using V=A h.

ρmix V=ρ1+V1+ρ2 V. The equation B.

Notice the following.

V is the defined volume in the column for the density measurement.

ρ1 (first liquid density) and ρ2 (second liquid density) are known values from the laboratory analysis.

ρmix is the calculated and known parameter from ρmix=ΔP/(g×h)
where h is a known physical height of the column for the measurement and ΔP is measure from the differential sensor.

Thus, between the equation A and B, there are only 2 unknowns, namely, V1 and V2. They are:

V1=V(ρmix−ρ2)/(ρ1−ρ2)

V2=V−V1=V(1−(ρmix−ρ2)/(ρ1−ρ2)).

Under dynamic condition where the mixed fluids are flowing, ΔP term will include friction factors.
Assume that ΔP=Pbottom−Ptop

Where Ptop=pressure at the top of the column,
Pbottom=pressure at the bottom of the column in the figure above.
   The flowing dynamic equation can be describe as

Ptop=Pdymanic_top+1/2ρmix v²+Ztop

Pbottom=Pdymanic_bottom+1/2ρmix v²+Zbottom.

### Where

Pdymanic_top; the incremental change in static pressure at the measurement point at the top due to dynamic flow (36).

Pdymanic_bottom; the incremental change in static pressure at the measurement point at the bottom due to dynamic flow (38).

ρmix: the average density of the flowing media,

v: the average flow velocity,

1/2ρmix v²: kinetic energy of the fluid,

Ztop: potential energy of the flowing fluid at the top (36),

Zbottom: potential energy of the flowing fluid at the bottom (38).

Therefore, 1/2ρmix v² is cancelled and results with:

ΔP=Pdymanic_bottom−Pdymanic_top+Zbottom−Ztop.

When the flow rate is small, then the dynamic pressure terms remain small to negligible. When it is fully static, ΔP=Zbottom−Ztop=ρmix g h
Thus under flowing condition, the more generic of the measurement ΔP is:

ΔP=ρmix g h−(Pdymanic_bottom−Pdymanic_top)

ΔP=ρmix g h−∈

Where ∈=(Pdymanic_bottom−Pdymanic_top), and denotes the incremental changes caused by frictions etc. ∈ term consists of the combination of fluid friction and the flow loop physical configuration. It is expected to remain a minor term for laminar flow and at the turbulent flow, it will have to be empirically assessed to ensure the influence of fluid property and mechanical geometry.

Referring again to FIG. 1, in this way, flow loop 10 may measure the volume (percentage) of the first liquid phase and the volume (percentage) of the second liquid phase in a three phase mixture comprised of one gas phase and two liquid phases.

In one embodiment, the mixture density is used as a parameter in the flow rate measurement performed by meter 32, when meter 32 is of the differential pressure type such as the eTube. Volume accumulation can be performed for appropriate periods of time, such as Hourly and Daily periods. Using the Volume percentages, accumulated volume can be determined for Liquid 1 and for Liquid 2. As noted earlier, a feature of one preferred embodiment is the measuring of oil and water volumes.

In one embodiment, inlet 20 and outlet 22 may be positioned higher than a midpoint on inlet vertical column 12 and outlet vertical column 14, respectively. This arrangement may allow flow loop 10 to accommodate a larger volume of the liquid mixture than the gas phase. The gas phase may flow through top horizontal section 16, while the liquid mixture may flow through bottom horizontal section 18. In other embodiments, inlet 20 and outlet 22 may be positioned at other heights on inlet vertical column 12 and outlet vertical column 14 to accommodate a different expected volume ratio of the gas phase to the liquid mixture.

Gas flow meter 28 may measure the flow rate of the gas phase flowing through top horizontal section 16. Liquid flow meter 32 may measure the flow rate of the liquid mixture flowing through bottom horizontal section 18. Valve 30 may be used to adjust the amount of the gas phase allowed to flow through top horizontal section 16. This adjustment may be used to ensure that none of the liquid mixture will flow through top horizontal section 16. Valve 30 may even be used to shut off flow through top horizontal section 16 in such a situation. Also, this adjustment may be necessary to ensure that the level of the liquid phase in inlet vertical column 12 does not drop below a minimum liquid level required for accurate operation of differential pressure measurement system 24.

The gas phase may again combine with the liquid mixture in outlet vertical column 14, and the three phase mixture may flow out of outlet vertical column 14 through outlet 22. The energy change in the gas phase and the liquid mixture may balance in the outlet vertical column 14 before the three phase mixture flows out through outlet 22.

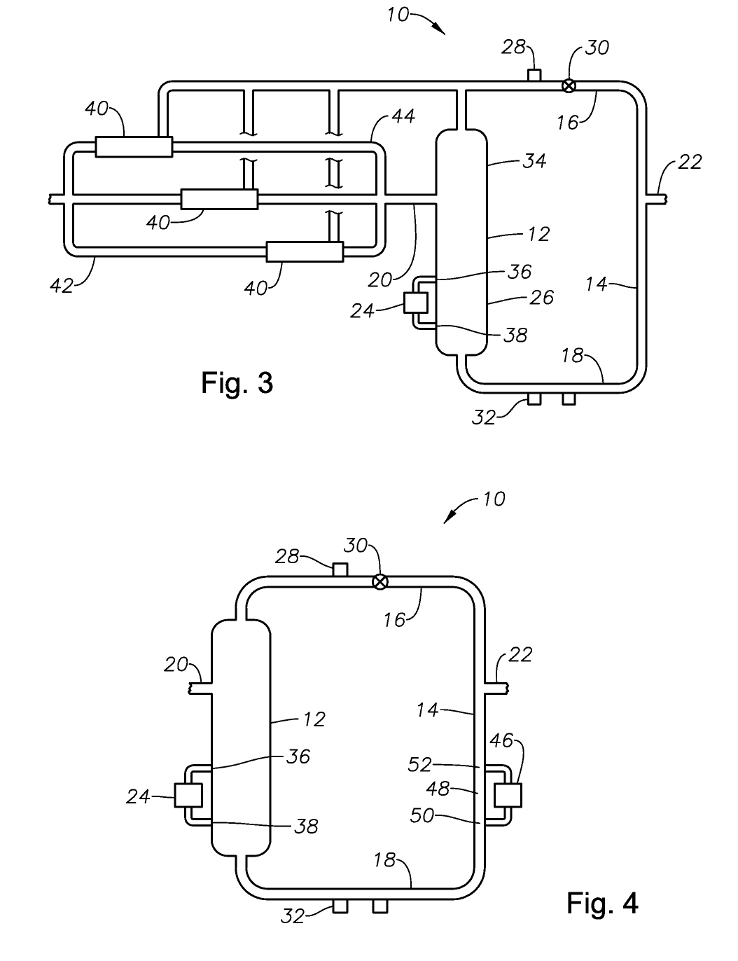

Referring to FIG. 3, a schematic view of the three-phase density measurement flow loop having a plurality of pre-separation horizontal pipe sections is illustrated. More particularly, FIG. 3 depicts, at the close to the outlet of horizontal pipe section 40, a branching pipe coming out of each pipe 40 that connects directly to the beginning of the horizontal section 16. To maintain similar pressure gradient, the layout of pipe 40 and the branching have to maintain very similar physical dimensions and orientations. This is to ensure that any gas separated in pipe 40 will be directed to the gas section of the loop 10. Otherwise, the separated gas will again be mixed with liquids in the conveyance section 44 to inlet 20 (as the diameter of the pipe narrows) only to be re-separated. This reduces the gas separation efficiency of the entire device. FIG. 3 is one of the preferred embodiments of this disclosure.

As seen in FIG. 3, a plurality of pre-separation horizontal pipe sections 40 may be fluidly connected by split section 42 and convergence section 44. Convergence section 44 may be fluidly connected to inlet vertical column 12 through inlet 20. This configuration allows pre-separation of the gas phase from the two liquid phases before the fluid is fed into inlet vertical column 12 of flow loop 10. This pre-separation step is useful where the fluid would be under turbulent flow conditions in the larger diameter inlet vertical column 12, which would render separation insufficient in inlet vertical column 12 alone. In other words, use of the plurality of pre-separation horizontal pipe sections 40 before flow loop 10 may increase the efficiency of gas/liquid separation under turbulent flow conditions. The number of pre-separation horizontal pipe sections 40 used may be based on the flow rate and the gas separation efficiency of a given fluid mixture of the system. For a system having a higher fluid flow rate, more pre-separation horizontal pipe sections 40 may be used.

A three phase mixture may be fed into split section 42 in which the three phase mixture is divided into separate flow paths, namely each of the plurality of pre-separation horizontal pipe sections 40. In the plurality of pre-separation horizontal pipe sections 40, a gas phase of the three phase mixture may begin to separate from two liquid phases due to gravity forces, buoyancy forces, and the larger diameter of pre-separation horizontal pipe sections 40 than the surrounding flow lines. In one embodiment, each of pre-separation horizontal pipe sections 40 may have a diameter of approximately six inches. The divided flow of the three phase mixture may be combined in convergence section 44, and the three phase mixture may then flow through inlet 20 into inlet vertical column 12 where the separation of the gas phase from the two liquid phases may continue. As described above, the gas phase may rise to upper section 34 of inlet vertical column 12, while a liquid mixture of the first and second liquid phases may flow to lower section 26.

A differential pressure may be measured for the liquid mixture at first vertical position 36 and second vertical position 38 in lower section 26 of inlet vertical column 12 using differential pressure measurement system 24. The measured differential pressure value may be adjusted for a friction pressure loss caused by frictional forces associated with the turbulent or laminar flow conditions of the liquid mixture in inlet vertical column 12. This adjustment for friction pressure loss may be accomplished by measuring a flow velocity of the liquid mixture in lower section 26 of inlet vertical column 12, and estimating the friction pressure loss using the measured flow velocity. The flow velocity may be calculated from the flow rate determined from meter 32 and the area of the inside of pipe 18,

Flow Velocity=Flow Rate/Pipe Area

The friction pressure loss may be estimated using the friction factor vs. Reynolds Number for pipe flow according to Moody (for instance, see L. F. Moody, Trans. ASME 66, 671 (1944)) The graph covers both the laminar and turbulent flow regime. In one preferred embodiment, only meter 32 is provided with the system. The differential pressure associated with gravity, also referred to as the gravity differential pressure, may be calculated by subtracting the friction pressure loss estimation from the measured differential pressure. The friction pressure loss adjustment may be accomplished by using an eTube™ flow meter as described in U.S. Pat. No. 7,653,489 and U.S. Pat. No. 7,623,975, which are both incorporated herein by reference.

The gravity differential pressure may be used to calculate the density of the liquid mixture using the formula: ρmix=(ΔP+∈)/(g×h). A volume percentage or mass percentage of each of first and second liquid phases in the liquid mixture may be calculated, and a volume may be calculated for each of first and second liquid phases, as described above.

Referring to FIG. 4, another embodiment of the flow loop 10 is depicted. This embodiment contains additional gravity differential pressure measurement points. FIG. 4 is useful for the explanation of eliminating the influence of the friction loss. The flow loop 10 includes a second differential pressure measurement system 46 positioned on lower section 48 of outlet vertical column 14. The column 14 diameter may be adjusted to the same as the diameter of column 12 for the purpose friction loss cancellation. Second differential pressure measurement system 46 may be a remote seal pressure transmitter. Second differential pressure measurement system 46 may measure a second differential pressure of the liquid mixture between first vertical position 50 and second vertical position 52 in outlet vertical column 14. First vertical position 50 in outlet vertical column 14 may be positioned at the same height as second vertical position 38 in inlet vertical column 12. Second vertical position 52 in outlet vertical column 14 may be positioned at the same height as first vertical position 36 in inlet vertical column 12.

The friction pressure loss adjustment required for turbulent flow conditions may be accomplished by measuring the first differential pressure of the liquid mixture in inlet vertical column 12 and measuring the second differential pressure of the liquid mixture in outlet vertical column 14. The first differential pressure of the liquid mixture will be a positive value, which will include a positive first gravity differential pressure (potential energy) and a negative first friction differential pressure. In other words, the first differential pressure of the liquid mixture will include a first gravity pressure increase and a first friction pressure loss. The second differential pressure of the liquid mixture will be a negative value, which will include a negative second gravity differential pressure and a negative second friction differential pressure. In other words, the second differential pressure of the liquid mixture will include a second gravity pressure loss and a second friction pressure loss. The first gravity differential pressure may be calculated (between first vertical position 36 and second vertical position 38 in inlet vertical column 12) by subtracting the second differential pressure value from the first differential pressure value, then dividing the difference in half. This calculation may be expressed by the following formula:

ΔP_{g1}=ρmix g h=1/2(ΔP₁−ΔP₂)

where ΔP_{g1} is the first gravity differential pressure (pressure at position 38 and at position 36), ΔP₁ is the first differential pressure, and ΔP₂ is the second differential pressure. This formula is derived from the following formulas for the first differential pressure and the second differential pressure:

(+)ΔP₁=(+)ΔP_{g1}+(−)ΔP_{f1}=ρmix g h−∈

(−)ΔP₂=(−)ΔP_{g2}+(−)ΔP_{f2}=ρmix g(−h)−∈

where ΔP_{f1} is the first friction differential pressure (the term is negative as the pressure drops in the direction of the flow), ΔP_{g2} is the second gravity differential pressure (the measurement is always negative for pressure at position 52 and at position 50), and ΔP_{f2} is the second friction differential pressure. Subtracting the second differential pressure from the first differential pressure yields the following formula:

ΔP₁−ΔP₂=2 ρmix g h

The first friction differential pressure, ΔP_{f1}(∈), and the second friction differential pressure, ΔP_{f2}(∈) will cancel one another in the above formula, leaving the following formula, where ΔP_{g1} is approximately equal to ΔP_{g2} (the same as ρmix g h):

ΔP₁−ΔP₂=(+)ΔP_{g1}+(+)ΔP_{g2}=2(ΔP_{g1})

The calculated first gravity differential pressure may be used to calculate the density of the liquid mixture using the formula ρmix=ΔP/(g×h) described above. A volume percentage or mass percentage of each of first and second liquid phases in the liquid mixture may be calculated using the pre-determined density for each of first and second liquid phases, as described above.

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

We claim:

1. A method of measuring a flowing volume and density of two liquid phases in a mixture with a gas phase comprising the steps of:
a) providing a flow loop comprising an inlet vertical column and an outlet vertical column interconnected by a top horizontal section and a bottom horizontal section;
b) feeding a three phase mixture into said inlet vertical column, wherein said three phase mixture comprises a gas phase, a first liquid phase, and a second liquid phase, wherein a density of said first liquid phase is lower than a density of said second liquid phase;
c) separating the gas phase from the first and second liquid phases in the inlet vertical column, such that the gas phase flows to an upper section of the inlet vertical column and through said top horizontal section and a liquid mixture of the first and second liquid phases flows to a lower section of the inlet vertical column and through said bottom horizontal section;
d) measuring a differential pressure of said liquid mixture in said lower section, below an inlet of the inlet vertical column;
e) measuring a flowing volume of said liquid mixture; and
f) calculating a density value for said liquid mixture using said differential pressure.

2. The method of claim 1, wherein a diameter of said inlet vertical column is larger than a diameter of said top horizontal section, a diameter of said bottom horizontal section, and a diameter of said outlet vertical column.

3. The method of claim 2, wherein said diameter of said inlet vertical column is approximately six inches.

4. The method of claim 1, wherein in step (d) said differential pressure is measured using a differential pressure sensor with remote diaphragm seals.

5. The method of claim 1, wherein in step (f) said conversion of said differential pressure to said density value for said liquid mixture is accomplished by dividing the differential pressure and the dynamic friction by the height between the measuring points of the differential sensor and the gravitational acceleration constant [ρmix=(ΔP+∈)/(g×h)].

6. The method of claim 1, further comprising the steps of:
g) determining a volume percentage of said liquid mixture for said first liquid phase;
f) determining a volume percentage of said liquid mixture for said second liquid phase;

7. The method of claim 6, wherein in step (g) said volume percentage of the liquid mixture for said first liquid phase is determined by calculating:
V1/V=(ρmix−ρ2)/(ρ1−ρ2),
wherein:
V is a first and second volume;
V1 is the first volume;
ρmix is the density value for liquid mixture;
ρ1 is first liquid density;
ρ2 is second liquid density.

8. The method of claim 7, wherein in step (h) said volume percentage of the liquid mixture for said second liquid phase is determined by calculating:
V2/V=1−V1/V.

9. The method of claim 1, further comprising the steps of:
f) determining a mass percentage of said first liquid phase in said liquid mixture (m1);
g) determining a mass percentage of said second liquid phase in said liquid mixture (m1).

10. The method of claim 9, wherein in step (f) said mass percentage of the liquid mixture for said first liquid phase is determined by calculating:
m1/mmix=(V1/V)*(ρmix/p1)
wherein:
mmix is the mass of the first liquid and the second liquid mixture in the vertical column volume of V;
V1 is the first volume;
V is the first and second volume;
ρmix is the density for liquid mixture;
ρ1 is the first liquid density;
m1 is the mass percentage of said first liquid phase.

11. The method of claim 9, wherein in step (g) said mass percentage of the liquid mixture for said second liquid phase is determined by calculating:
m2/mmix=(V2/V)*(ρmix/ρ2)
wherein:
mmix is the mass of the first liquid and the second liquid;
m2 is the mass percentage of said second liquid phase;
V is the first and second volume;
V2 is the second volume;
ρmix is the density value for liquid mixture;
ρ2 is the second liquid density.

12. The method of claim 1, further comprising the step of:
g) measuring a flow rate of said liquid mixture in said bottom horizontal section of said flow loop.

13. The method of claim 1, further comprising the step of:
g) measuring a flow rate of said gas phase in said top horizontal section of said flow loop.

14. The method of claim 1, wherein said flow loop further comprises a valve positioned on said top horizontal section for adjusting a flow rate of said gas phase, and wherein said method further comprises the step of: adjusting a liquid level within said inlet vertical column by adjusting said flow rate of said gas phase using said valve.

15. The method of claim 14, wherein said liquid level is adjusted in order to maintain a minimum liquid level required for measuring said differential pressure of said liquid mixture in said lower section of the inlet vertical column in step (d).

16. The method of claim 1, wherein said three phase mixture is under turbulent flow conditions, and wherein the method further comprises the steps of:
a1) feeding said three phase mixture into a plurality of horizontal pipe sections and beginning the separation of the gas phase from the first and second liquid phases in the plurality of horizontal pipe sections before feeding the three phase mixture into the inlet vertical column of the flow loop.

17. The method of claim 16, wherein said plurality of horizontal pipe sections are configured in a series upstream of said flow loop.

18. The method of claim 16, wherein said plurality of horizontal pipe sections are positioned parallel to one another between said split section and said convergence section, and wherein step (a1) further comprises: feeding said three phase mixture through said split section and into said plurality of horizontal pipe sections, and beginning the separation of the gas phase from the first and second liquid phases in the series of horizontal pipe sections before feeding the three phase mixture through said convergence section and into said inlet vertical section of the flow loop.

19. The method of claim 16, wherein a diameter of each of said plurality of horizontal pipe sections is approximately six inches.

20. The method of claim 1, wherein said three phase mixture is under turbulent flow conditions, and wherein said method further comprises the step of:
d1) adjusting said differential pressure of said liquid mixture measured in step (d) for a friction pressure loss, wherein said friction pressure loss is a pressure drop caused by friction forces in said liquid mixture under the turbulent flow conditions.

21. The method of claim 20, wherein step (d1) further comprises the steps of:
i) measuring a flow rate of said liquid mixture and calculating a flow velocity of said liquid mixture;
ii) estimating said friction pressure loss using said flow velocity and fluid properties; and
iii) calculating a gravity differential pressure by subtracting said friction pressure loss estimated in step (ii) from said differential pressure;
and wherein step (f) further comprises: calculating said density value for said liquid mixture using said gravity differential pressure.

22. The method of claim 20, further comprising the steps of:
i) measuring a second differential pressure of said liquid mixture in a lower section of the outlet vertical column; and
ii) calculating a gravity differential pressure by subtracting said second differential pressure from said first differential pressure, then dividing the difference in half;
and wherein step (e) further comprises: calculating said density value for said liquid mixture using said gravity differential pressure.
